(19) United States
(12) Patent Application Publication
(10) Pub. No.: US 2012/0246492 A1
(43) Pub. Date: Sep. 27, 2012

(54) REMOTE POWER GROUP DISTRIBUTION CONTROL SYSTEM AND METHOD THEREFOR

(76) Inventors: Lien-Hsun HO, Taipei (TW); Hsien-Hsun Liu, Taipei (TW); Hung-Ming Hsieh, Taipei (TW); Hong-Chun Chien, Taipei (TW)

(21) Appl. No.: 13/070,541

(22) Filed: Mar. 24, 2011

(51) Int. Cl. G06F 1/00; G06F 3/00

(52) U.S. Cl. 713/300

(57) ABSTRACT

A remote power group distribution control system has a host computer, at least one network server and multiple power distribution units (PDUs) connected to the host computer through the at least one network server. The host computer has a power distribution control module. Each PDU is connected with multiple power consuming equipment having identical or similar characteristics to supply an operating power and an uninterruptible power. When the power distribution control module is executed, the host computer searches the PDUs connected thereto through the at least one network server, displays all power-consuming equipment connected to each PDU, generates a group management window to assign each power-consuming equipment to a group, and remotely controls the power consuming equipment on a group basis. Accordingly, the present invention addresses a solution conveniently powering on or off remote power-consuming equipment pertaining to a group.

### BACKGROUND OF THE INVENTION

1. Field of the Invention

The present invention relates to a remote power group distribution control system and method therefor, and more particularly to a control system and method collectively controlling to power on and off remote power consuming equipment based on a group planning through a single interface.

2. Description of the Related Art

Power management of information technology (IT) equipment is a key factor to ensure that IT equipment can normally and securely operate. To tackle the power supply demand of a variety of IT equipment and peripheral equipment, rack-mount power distribution units (PDU) are mounted to the rack for IT equipment. Each rack-mount PDU has multiple sockets connected to multiple IT equipment, for example, servers, routers, firewalls and the like, and peripheral equipment, for example, printers, displays, fax machines and the like, to distribute power to the IT equipment and peripheral equipment connected to the rack-mount PDU. Each rack-mount PDU is connected with an uninterruptible power supply in support of seamless power supply. Conventional rack-mount PDUs have many types such as basic type, instrument control type, switching type, intelligent type and the like. The switching type and the intelligent type PDUs are all equipped with remote power-on and power-off functions, and in other words, to power on or power off IT or peripheral equipment through a network.

Upon actual implementation, although each IT equipment or peripheral equipment can be remotely powered on or off through distributed power and remote power-on or power-off function of the PDU, powering off idle IT equipment or peripheral equipment is inconveniently performed by sequentially and remotely logging in each idle equipment or peripheral equipment and powering off one equipment after another. Basically, most of the peripheral equipment routinely has a fixed idle cycle. For example, many printers are idle after work. As a general rule, these printers can be powered off after work. Since these printers are controlled by and supplied with power therethrough, even if these printers are of a same attribute, it is necessary to sequentially log in and power off these printers. Once these printers are powered off, they have to be logged in and powered back on if they are intended to be operational again. Owing to such inefficient and complicated operation procedures, users are reluctant to go through the tedious procedures to power on or power off IT equipment or peripheral equipment, thereby impacting power utilization and operational utilization of the equipment.

### SUMMARY OF THE INVENTION

An objective of the present invention is to provide a remote power group distribution control system and method collectively controlling to power on and off remote power consuming equipment based on a group planning through a single interface.

To achieve the foregoing objective, the remote power group distribution control system has multiple power distribution units, at least one network server, and a host computer.

Each power distribution unit has multiple power outlets adapted to respectively connect to multiple power-consuming equipment.

The at least one network server is respectively connected to the power distribution units.

The host computer is connected to the power distribution units through the at least one network server, and has a power distribution control module generating a group management window adapted to assign each power-consuming equipment connected to a corresponding power distribution unit to a group to which the power-consuming equipment pertains.

To achieve the foregoing objective, the remote power group distribution control method has steps of:

searching multiple power distribution units connected to a network;

generating a facility management screen listing each power distribution unit connected to the network and multiple power-consuming equipment respectively connected to the power distribution unit, and assigning each power-consuming equipment to a group to which the power-consuming equipment pertains; and

generating a group manipulation screen showing the group-assigned power consuming equipment, providing at least one control option, and selectively executing the at least one control option to control a designated group.

When the power distribution control module of the host computer is executed, the module searches all the power distribution units connected to the host computer and all power-consuming equipment connected to each power distribution unit through the at least one network server to assign each power-consuming equipment to a group. Hence, the power-consuming equipment can be remotely and conveniently powered on or off on a group basis.

The remote power group distribution control method can assign each power-consuming equipment connected to the network to a group so as to remotely and collectively power on or off multiple power-consuming equipment pertaining to a group in one shot.

Other objectives, advantages and novel features of the invention will become more apparent from the following detailed description when taken in conjunction with the accompanying drawings.

### BRIEF DESCRIPTION OF THE DRAWINGS

FIG. 1 is a system architecture diagram of a remote power group distribution control system in accordance with the present invention;

FIG. 2 is a schematic view of a group management window of the remote power group distribution control system in FIG. 1;

FIG. 3 is another schematic view of the group management window in FIG. 2;

FIG. 4 is a schematic view of another group management window of the remote power group distribution control system in FIG. 1; and

FIG. 5 is a flow diagram of a remote power group distribution control method in accordance with the present invention.

### DETAILED DESCRIPTION OF THE INVENTION

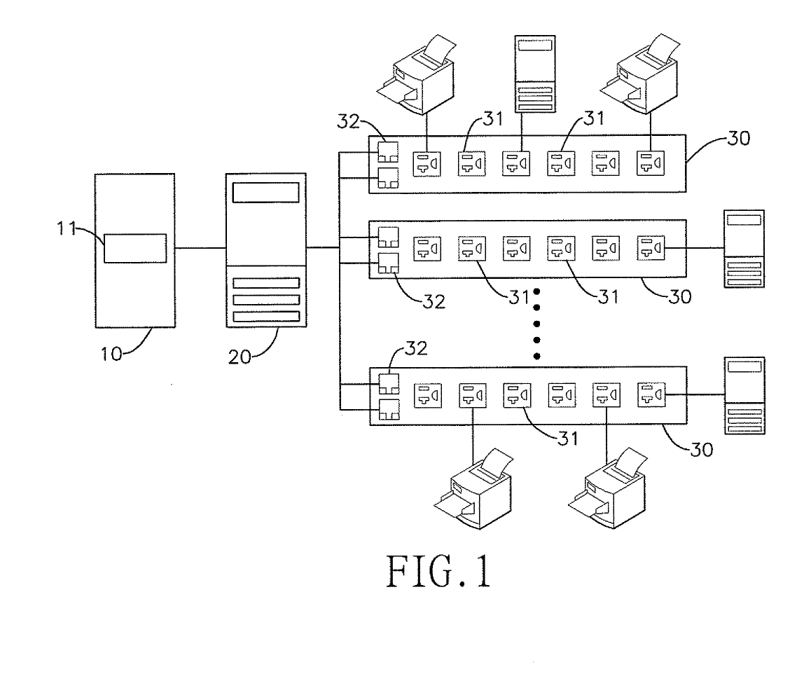

With reference to FIG. 1, a remote power group distribution control system in accordance with the present invention has multiple power distribution units (PDUs) 30, at least one network server 20 and a host computer 10.

Each PDU 30 has multiple power outlets 31 and at least one network port 32. The power outlets 31 are respectively connected with multiple power-consuming equipment so that each power consuming equipment can acquire an operating power and emergency power through one of the PDUs 30. The at least one network server 20 is respectively connected to the at least one network port 32. The communication network used to connect each PDU 30 and a corresponding network server 20 is a wireline local area network or wireless local area network, such as LAN or WLAN. The communication protocols involved in connecting each PDU 30 and a corresponding network server 20 can be wireline and/or wireless communication protocols, such as WIFI, ZIGBEE, and the like.

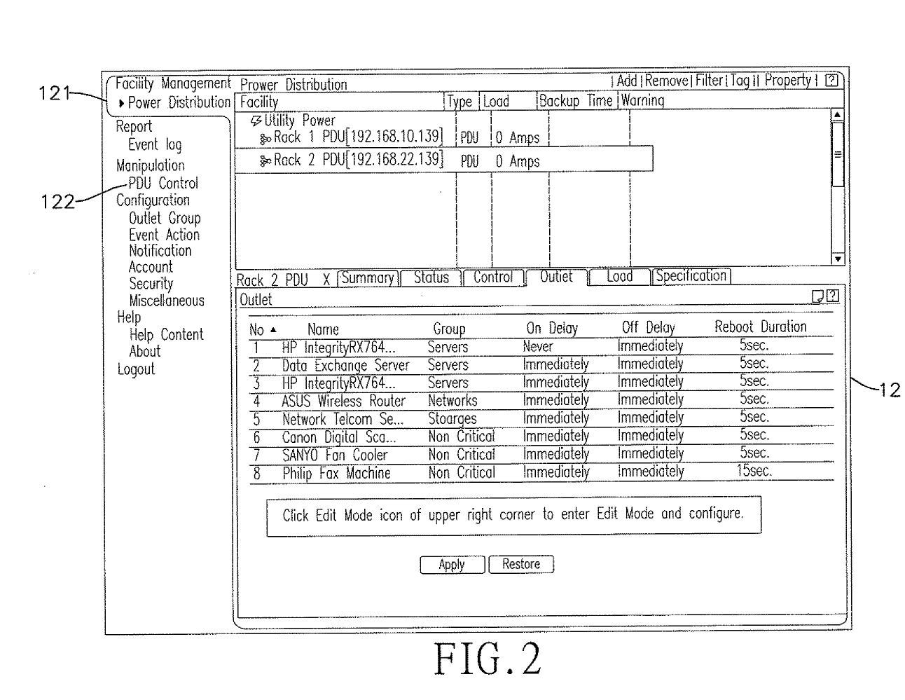

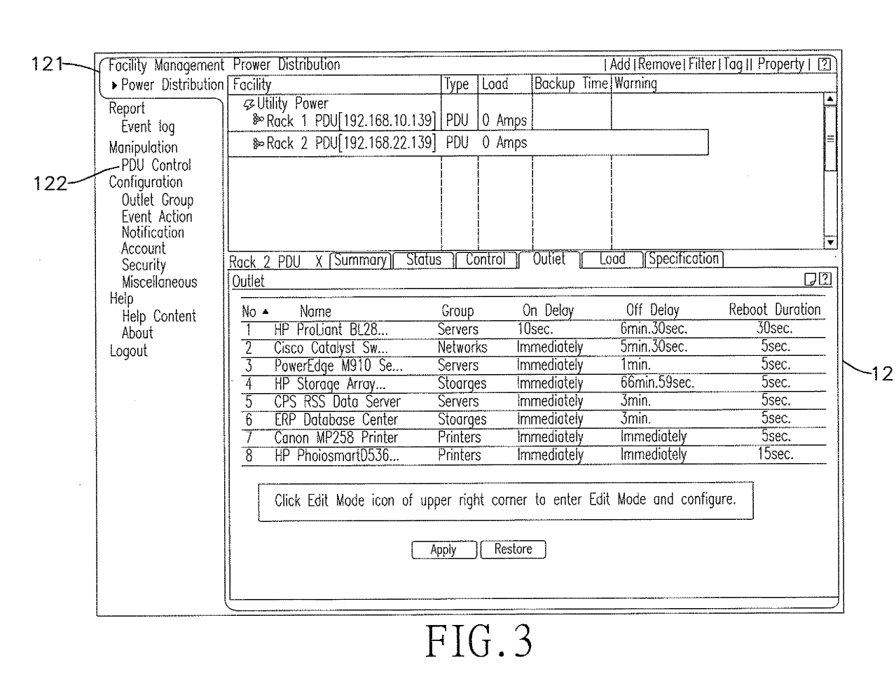

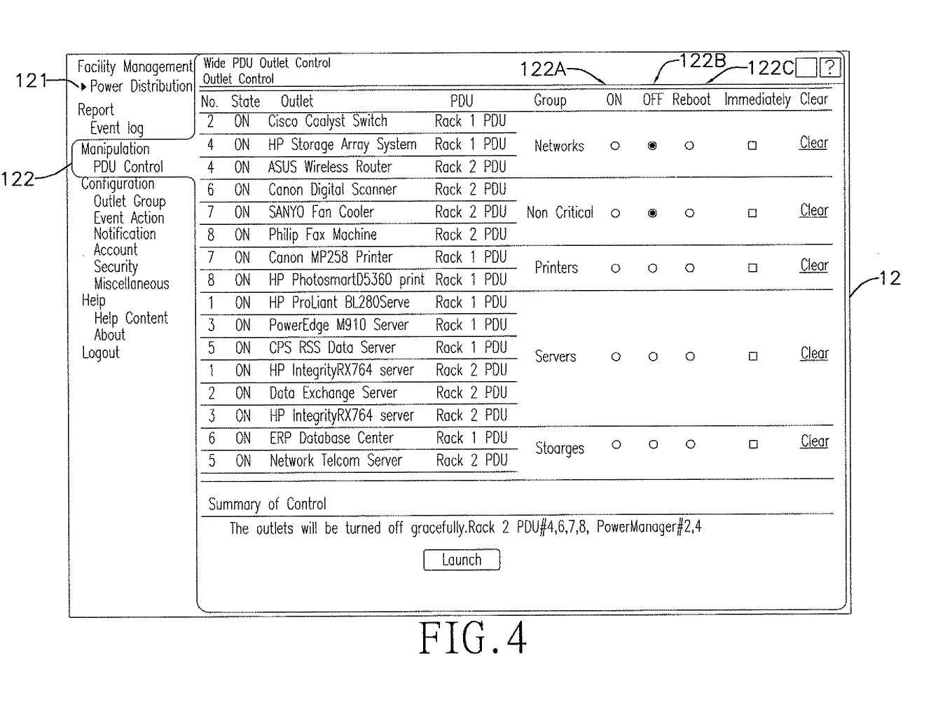

The host computer 10 is connected to each PDU 30 through the at least one network server 20, and is embedded with a power distribution control module 11. With reference to FIGS. 2 to 4, the power distribution control module 11 generates a group management window 12 to assign and control each power-consuming equipment connected to a corresponding PDU 30 on a group basis. After the host computer 10 is up and running and executes the power distribution control module 11, the host computer 10 starts searching each PDU 30 connected to the host computer 10 and each power-consuming equipment connected to the connected PDU 30 through the at least one network server 20. After the host computer 10 acquires information of each power-consuming equipment connected to the corresponding PDU, the group management window 12 generated by the power distribution control module 11 provides a facility management screen 121 and a group manipulation screen 122.

The facility management screen 121 lists the searched power distribution units 30 and the power-consuming equipment connected thereto. The facility management screen 121 has a facility list on an upper portion thereof categorized by columns of facility, type, load, backup time and warning and listing two searched PDUs 30. The facility names of the two PDUs are “Rack 1 PDU” and “Rack 2 PDU” respectively. An IP address is bracketed right behind each of “Rack 1 PDU” and “Rack 2 PDU”. The type column shows a facility type being “PDU” for both “Rack 1 PDU” and “Rack 2 PDU”. The load column shows 0 ampere for both “Rack 1 PDU” and “Rack 2 PDU”.

If one of “Rack 1 PDU” and “Rack 2 PDU” is picked (“Rack 2 PDU” as shown in FIG. 2), basic information of each power-consuming equipment connected to the “Rack 2 PDU” is displayed on a lower portion of the facility management screen 121. The basic information is categorized by columns of number, name, group, on delay, off delay, reboot duration and the like. Each entry in the group column is editable and is referred to a group to which a power-consuming equipment is assigned. For example, the group entries of the first three pieces of power-consuming equipment are all assigned with identical group, “Servers”, and hence, the first three pieces of power-consuming equipment belong to a same group. When “Rack 1 PDU” is picked, the basic information of each power consuming equipment connected with “Rack 1 PDU” is displayed on the lower portion of the facility management screen 121. As mentioned, the group column listed on the lower portion of the facility management screen 121 can be used to assign the group to which each power-consuming equipment pertains.

When each power-consuming equipment is assigned to a group, each power-consuming equipment can be demonstrated on the group management window 12 designated by the assigned group. The power-consuming equipment respectively connected to “Rack 1 PDU” and “Rack 2 PDU” is reorganized with the assigned group, such as “Networks”, “Non Critical”, “Printers”, “Servers”, “Storages” and the like, and is displayed on the group manipulation screen 122 provided by the group management window 12. The group manipulation screen 122 provides multiple control options 122A, 122B, 122C to each group so as to simultaneously power on, power off or reboot all power-consuming equipment in each group. In other words, when intending to power off all the power-consuming equipment in the “Network” group, users just need to click the “Off” control option 122B of the “Network” group and the “Launch” option to confirm the power-off action. Similarly, when intending to power on all the power-consuming equipment in the “Network” group, users just need to click the “On” control option 122A of the “Network” group and the “Launch” option to confirm the power-on action.

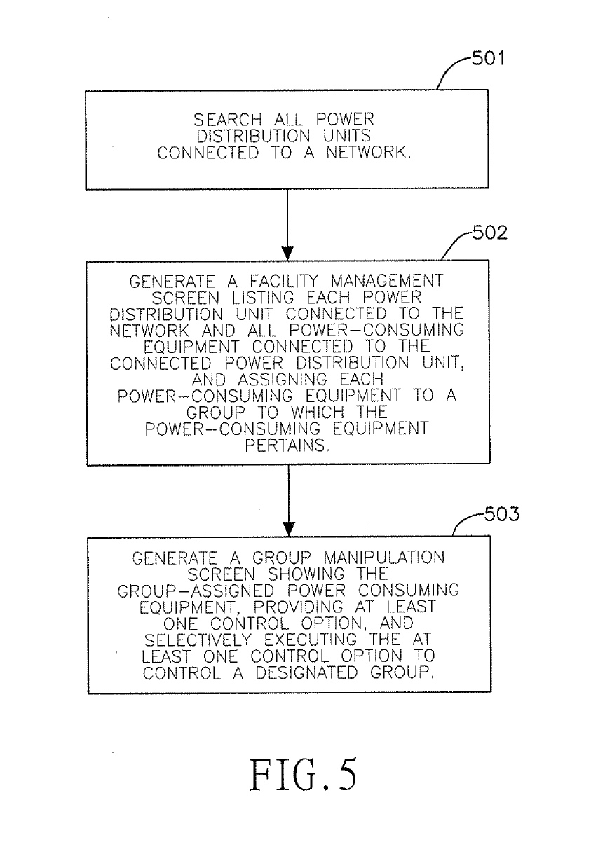

With reference to FIG. 5, a remote power group distribution control method in accordance with the present invention has steps of:

searching all power distribution units connected to a network 501;

generating a facility management screen listing each power distribution unit connected to the network and all power-consuming equipment connected to the connected power distribution unit, and assigning each power-consuming equipment to a group to which the power-consuming equipment pertains 502; and

generating a group manipulation screen showing the group-assigned power consuming equipment, providing at least one control option, and selectively executing the at least one control option to control a designated group 503.

The group manipulation screen at least has an “On” control option and an “Off” control option to remotely power on and off the power consuming equipment pertaining to an identical group.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A remote power group distribution control system comprising:
multiple power distribution units, each power distribution unit having multiple power outlets adapted to respectively connect to multiple power-consuming equipment;
at least one network server respectively connected to the power distribution units; and
a host computer connected to the power distribution units through the at least one network server, and having a power distribution control module generating a group management window adapted to assign each power-consuming equipment connected to a corresponding power distribution unit to a group to which the power-consuming equipment pertains.

2. The remote power group distribution control system as claimed in claim 1, wherein the at least one network server is connected to each power distribution unit through a local area network.

3. The remote power group distribution control system as claimed in claim 1, wherein the at least one network server is connected to each power distribution unit through a wireless network.

4. The remote power group distribution control system as claimed in claim 1, wherein the group management window has:
a facility management screen listing each power distribution unit and the corresponding power-consuming equipment connected to the power distribution unit, and assigning each power-consuming equipment to a group to which the power-consuming equipment pertains; and
a group manipulation screen displaying each power-consuming equipment having a defined group, and providing and selectively executing at least one control option associated with the power-consuming equipment assigned in each group.

5. The remote power group distribution control system as claimed in claim 2, wherein the group management window has:
a facility management screen listing each power distribution unit and the corresponding power-consuming equipment connected to the power distribution unit, and assigning each power-consuming equipment to a group to which the power-consuming equipment pertains; and
a group manipulation screen displaying each power-consuming equipment having a defined group, and providing and selectively executing at least one control option associated with the power-consuming equipment assigned in each group.

6. The remote power group distribution control system as claimed in claim 3, wherein the group management window has:
a facility management screen listing each power distribution unit and the corresponding power-consuming equipment connected to the power distribution unit, and assigning each power-consuming equipment to a group to which the power-consuming equipment pertains; and
a group manipulation screen displaying each power-consuming equipment having a defined group, and providing and selectively executing at least one control option associated with the power-consuming equipment assigned in each group.

7. The remote power group distribution control system as claimed in claim 4, wherein the group manipulation screen has an “On” control option and an “Off” control option.

8. The remote power group distribution control system as claimed in claim 5, wherein the group manipulation screen has an “On” control option and an “Off” control option.

9. The remote power group distribution control system as claimed in claim 6, wherein the group manipulation screen has an “On” control option and an “Off” control option.

10. The remote power group distribution control system as claimed in claim 7, wherein the facility management screen has:
a facility list listing the searched power distribution units; and
basic information of the power consuming equipment showing basic information of each power consuming equipment connected to a selected power distribution unit.

11. The remote power group distribution control system as claimed in claim 8, wherein the facility management screen has:
a facility list listing the searched power distribution units; and
basic information of the power consuming equipment showing basic information of each power consuming equipment connected to a selected power distribution unit.

12. The remote power group distribution control system as claimed in claim 9, wherein the facility management screen has:
a facility list listing the searched power distribution units; and
basic information of the power consuming equipment showing basic information of each power consuming equipment connected to a selected power distribution unit.

13. A remote power group distribution control method comprising steps of:
searching multiple power distribution units connected to a network;
generating a facility management screen listing each power distribution unit connected to the network and multiple power-consuming equipment respectively connected to the power distribution unit, and assigning each power-consuming equipment to a group to which the power-consuming equipment pertains; and
generating a group manipulation screen showing the group-assigned power consuming equipment, providing at least one control option, and selectively executing the at least one control option to control a designated group.

14. The remote power group distribution control method as claimed in claim 13, wherein the group manipulation screen has an “On” control option and an “Off” control option.
